(19) United States
(12) Patent Application Publication
(10) Pub. No.: US 2010/0285268 A1
(43) Pub. Date: Nov. 11, 2010

(54) FLOOR COVERING STRUCTURE CONTAINING VELCRO

(76) Inventor: Pen-Yuan Chen, Tu Cheng City (TW)

Correspondence Address: SINORICA, LLC, 2275 Research Blvd., Suite 500, ROCKVILLE, MD, 20850, US

(21) Appl. No.: 12/486,990

(22) Filed: Jun. 18, 2009

(30) Foreign Application Priority Data
May 8, 2009 (TW) 98207955

(51) Int. Cl. B32B 3/06

(52) U.S. Cl. 428/100

(57) ABSTRACT

A floor covering structure containing velcro, comprising a surface layer and a bottom layer. The surface layer includes a first velcro layer and a surface material layer, the surface material layer is provided on the first velcro layer; and the bottom layer includes a second velcro layer, such that the two velcro layers can be engaged and connected to each other. In addition, each of the floor tiles can be assembled together through dislocation and connection. In the floor covering structure containing velcro, the surface layer and the bottom layer of can be engaged to each other through a velcro layer, thus achieving a temporary & stable connection, so that in assembling this kind of floor tiles, and if it is required, the surface layer can be torn off and removed from the top surface of the bottom layer, and then it can be reconnected on another bottom layer.

### BACKGROUND OF THE INVENTION

1. Field of the Invention

The present invention relates to a floor covering structure, and in particular to a floor covering structure containing velcro.

2. The Prior Arts

Along with the raise of living standard in recent years, more and more people are paying attention and putting emphases on the quality of living environment. In addition to raising the quality of living quarters and beautifying the indoor environment, the emphasis is also on providing a better living environment for young children at home. For this reason, many a person tend to put a layer of tile structure on the ground of a house, such as ceramic tiles, floor tiles, plastic tiles, or carpet, etc., so that people walking moving on the floor tile structure tend to feel safe and comfortable both physically and mentally, such that their feet feel comfortable, thus they can fully relaxed.

In situations that various tile structures mentioned above are to be placed on a ground made of cement, and in order that the tiles can not be moved sideways in a left or right direction, then each of the floor tiles has to be glued on the ground by means of a self-adhesive tape or adhesive, hereby achieving the purpose of fixing tiles. However, in situations that each of the tiles is placed and glued onto the ground one-by-one through utilizing the self-adhesive tape or adhesive, and in case that the floor tiles are not aligned & connected properly and correctly to each other out of negligence, thus creating gaps between them, then such glued-on floor tiles must be detached and removed, and then to be glued on the floor again properly. As such, the bottom of floor tiles are liable to be damaged, or even when detaching and removing the floor tiles, the entire floor tile could be broken. In order words, the results of this kind of work method of the prior art are not quite satisfactory.

### SUMMARY OF THE INVENTION

In view of the problems and shortcomings of the prior art, the present invention discloses a floor covering structure realized through utilizing velcro, so as to overcome the shortcomings and problems of the prior art.

A major objective of the present invention is to provide a floor covering structure containing velcro, wherein, its surface layer and bottom layer can be made to engage each other through a velcro layer, thus achieving a temporary and stable connection, such that in assembling such a kind of floor tiles, and if it is required, the surface layer can be torn off and removed from a top surface of a bottom layer, and then it can be reconnected together with another bottom layer again, while keeping the surfaces of the surface layer and bottom layer undamaged and intact.

To achieve the above-mentioned objective, the present invention provides floor covering structure containing velcro, comprising a surface layer and a bottom layer. The surface layer includes a first velcro layer and a surface material layer, the surface material layer is provided on the first velcro layer, and the bottom layer includes a second velcro layer, such that the two velcro layers can be engaged and connected to each other through the engagement of their glochids.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a perspective view of a floor covering structure containing velcro according to a first embodiment of the present invention;

FIG. 2 is a cross section view of a floor covering structure containing velcro according to a first embodiment of the present invention;

FIG. 3 is a top view of a floor covering structure containing velcro according to a first embodiment of the present invention;

FIG. 4 is a schematic diagram of a raised fabric and protrusion hooks of a velcro layer according to a first embodiment of the present invention;

FIG. 5 is a perspective view of protrusion hooks according to a first embodiment of the present invention;

FIG. 6 is a schematic diagram of engagement of a raised fabric and protrusion hooks of a velcro layer according to a first embodiment of the present invention;

FIG. 7 is a perspective view of a floor covering structure composed of floor tiles according to a first embodiment of the present invention; and

FIG. 8 is a perspective view of a floor covering structure containing velcro according to a second embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the present invention, a floor covering structure containing velcro is disclosed, that can be applied into the fields of various floor covering structures, such as floor tile, ceramic tile, carpet, and a combination of floor tiles, etc. without being restricted to any particular field. In the following, a floor tile structure is taken as an example in explaining the floor covering structure containing velcro of the present invention.

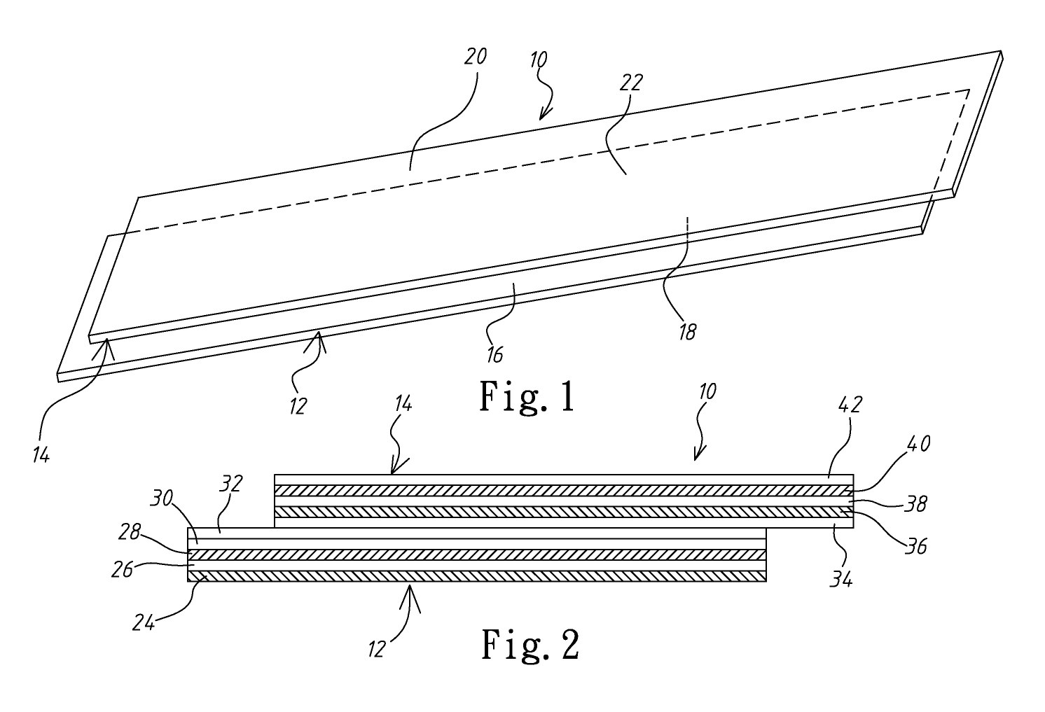

Refer to FIG. 1 for a perspective view of a floor covering structure containing velcro according to a first embodiment of the present invention. As shown in FIG. 1, a floor tile structure 10 mainly consists of two layers: a bottom layer 12, and a surface layer 14, both layers 12 and 14 are of rectangular shapes having the same surface area, and a bottom surface of a surface layer 14 is bonded onto a top surface of bottom layer 12, so that the surface layer 14 in on top of the bottom layer 12. The bottom layer 12 includes an L-shaped first offset area 16 along a portion of its edge, and the remaining portion of bottom layer 12 is a rectangular-shaped first overlapping area 18. In addition, the surface layer 14 includes an L-shaped second offset area 20 along a portion of its edge, and the remaining portion of surface layer 14 is a rectangular-shaped second overlapping area 22. Since the length sides and width sides of bottom layer 12 and surface layer 14 are parallel to each other respectively, and the corresponding portions of bottom layer 12 and surface layer 14 are offset to each other a horizontal distance and a vertical distance, so that a first offset area 16 of the bottom layer 12 extends and protrudes outside an edge of the surface layer 14, the second offset area 20 of surface layer 14 extends and protrudes outside an edge of the bottom layer 12, and the first and second overlapping areas 18 and 22 overlap each other.

Refer to FIG. 2, the bottom layer 12 and the surface layer 14 each comprises a structure of several layers, including a velcro layer, as will be described as follows. As shown in FIG. 2, the bottom layer 12 includes a first bottom material layer 24, located at the lowest portion of the bottom layer 12. The bottom surface of the first bottom material layer 24 is a specially processed slide-prevention surface. In other words, through the application of this slide-prevention surface, the bottom layer 12 can be placed directly on the ground, and it will not slide easily, and this way of processing is quite different from the conventional technology that the ground has to be first leveled evenly before the floor tiles can be placed on the leveled ground. In addition, the bottom layer 12 can be removed directly from the surface of the ground without damaging the surface of the ground or the bottom layer 12 itself. Moreover, when it is found that the present placement position of a floor tile is not appropriate, and it is desired to move the floor tile to some other place, then this can be realized easily by moving the bottom layer 12 manually to/and placing on other places. Conventionally, when a floor tile is removed from the ground, the floor tile itself will be damaged beyond further usage. However, in the present invention, since the bottom layer 12 can be kept wholly intact when it is removed from the ground, such that in case that after removing the bottom layer 12, the user would like to use it again, then the undamaged and wholly intact bottom layer 12 can be reused again without having to buy an additional new bottom layer, thus relieving the user of the unnecessary trouble and financial burden. Furthermore, the top surface of a first bottom material layer 24 is stacked thereon from bottom to top with a wholly overlapped first intermediate bottom material layer 26, a first surface material layer 28, a first transparent material layer 30, and a first velcro layer 32 respectively. The first velcro layer 32 is composed of the following materials: plastic (PVC: Polyvinylchloride), di-isononyl phthalate (DINP), stabilizer, colophony, or limestone powder, it further includes Aluminum hydroxide (Al(OH)₃) as an anti-flaming agent, hereby having fire-prevention and anti-flaming capabilities. As such, the bottom layer 12 is formed by a first bottom material layer 24, a first intermediate bottom material layer 26, a first surface material layer 28, a first transparent material layer 30, and a first velcro layer 32 respectively.

The surface layer 14 includes a second velcro layer 34, located at the lowest portion of the surface layer 14. The bottom surface of layer 34 is connected to a top surface of the first velcro layer 32. The material composition of the second velcro layer 34 is the same as that of the first velcro layer 32 mentioned above, thus the properties of the second velcro layer 34, such as the anti-flaming property of the second velcro layer 34 is the same as that of the first velcro layer 32. Moreover, the top surface of the second velcro layer 34 is stacked thereon from bottom to top with a wholly overlapped a second bottom material layer 36, a second intermediate bottom material layer 38, a second surface material layer 40, a second transparent material layer 42. Wherein, the top surface of the second transparent material layer 42 is processed to be an anti-fungi & wear-resistance surface. As such, the surface layer 14 is formed by a second velcro layer 34, a second bottom material layer 36, a second intermediate bottom material layer 38, and a second surface material layer 40, and a second transparent material layer 42.

In the following, an optimal size design of floor tile structure according to a preferred embodiment of the present invention is described. In order to ensure the flexibility of the entire floor tile structure, such that the floor tiles can be placed along the profiles of the floor surface, thus each layer of a structure included in a bottom layer 12 and a surface layer 14 is of a specific thickness, such as the thickness of the first bottom material layer 24 is 0.99 mm, the thickness of first intermediate bottom material layer 26 is 0.8 mm, the thickness of the first surface material layer 28 is 0.07 mm, the thickness of the first transparent material layer 30 is 0.3 mm, the thickness of the first velcro layer 32 is 0.48 mm, the thickness of the second velcro layer 34 is 0.48 mm, the thickness of the second bottom material layer 36 is 0.99 mm, the thickness of the second intermediate bottom material layer 38 is 2.8 mm, the thickness of the second surface material layer 40 is 0.07 mm, and the thickness of the second transparent material layer 42 is 0.3 mm.

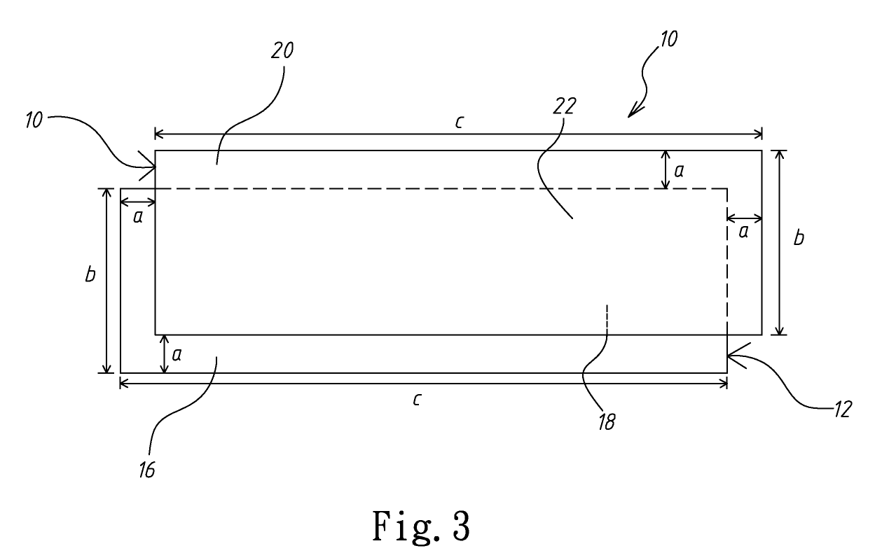

Subsequently, refer to FIG. 1 and FIG. 3 simultaneously, FIG. 3 is a top view of the structure of FIG. 1. Due to the relative offset and dislocation of a surface layer 14 relative to a bottom layer 12, such that the nearest distance between the length-side of surface layer 14 and the length-side of bottom layer 12 is a, namely, 10˜50 mm; while the nearest distance between the width-side of surface layer 14 and the width-side of bottom layer 12 is “a”, that is the same as the nearest distance between the length-side of surface layer 14 and the length-side of bottom layer 12. Furthermore, the width and length of surface layer 14 are “b” and “c” respectively, namely, 152.4 mm and 914.4 mm respectively.

In situations that the top surface of the first velcro layer is made of raised fabric, then the bottom surface of the second velcro layer is provided with a plurality of protrusion hooks, such that the two velcro layers can be engaged to each other by making use of the raised fabric and protrusion hooks, hereby connecting the surface layer 14 and the bottom layer 12 together in an up-down manner, and forming a temporary and stable connection. In situations that the top surface of the first velcro layer is provided with a plurality of protrusion hooks, while the bottom surface of the second velcro layer is made of raised fabric, then the surface layer 14 and bottom layer 12 can be connected together in an up-down manner as mentioned above to form a temporary and stable connection. In addition, the raised fabric and protrusion hooks can be replaced by velcro fabric and plastic hooks respectively.

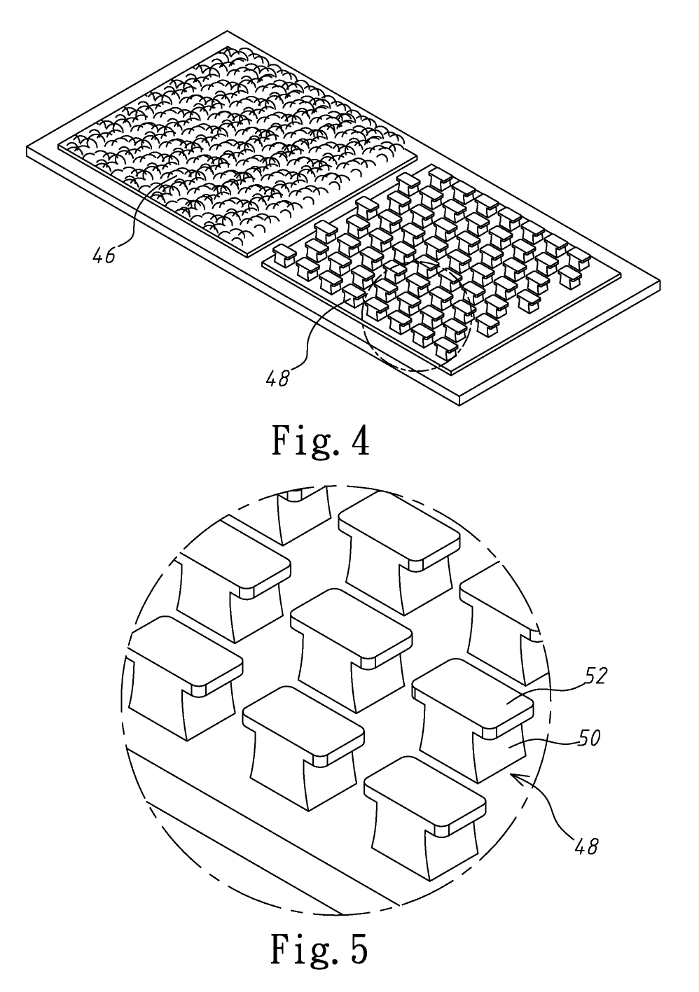

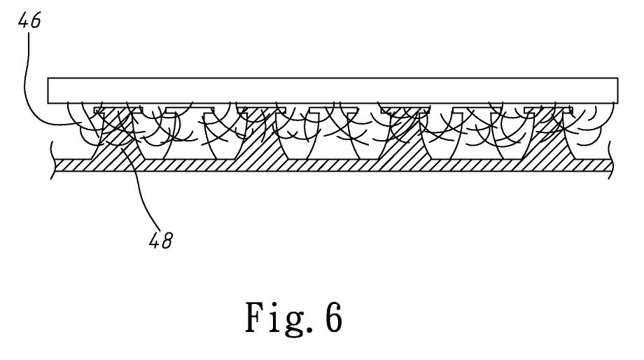

Refer to FIG. 4 for a schematic diagram of a raised fabric 46 and a plurality of protrusion hooks 48 of a velcro layer according to a first embodiment of the present invention. Wherein, the height of the protrusion hook is 0.4mm, while its density is 315 units/cm². In the present invention, the shape of protrusion hook 48 is of a special design. In this regard, refer to FIG. 5 for a perspective view of protrusion hooks according to a first embodiment of the present invention. As shown in FIG. 5, the protrusion hook 48 is composed of a vertical portion 50 and a horizontal portion 52, such that the vertical portion 50 is connected to a horizontal portion 52 vertically in forming a T-shape structure. Therefore, a part of a horizontal portion 52 protrudes outside the edge of a vertical portion 50. As shown in FIG. 6, the protruded portion of protrusion hook 48 is used to engage raised fabric 46, such that in assembling such floor tiles, and when it is found that the attached/glued on position of a surface layer 14 is incorrect or inappropriate, then the surface layer 14 can be torn off and removed from the bottom layer 12, and then proceed with the reconnection as required, since the surfaces of the surface layer 14 and bottom layer 12 remain undamaged and intact. In addition, through the application of velcro layer in connecting the floor tiles, not only the steps of glue-bonding can be saved and eliminated, but the installation efforts of professional mechanics are also not required. As such, the cost of installing floor tiles can be reduced significantly.

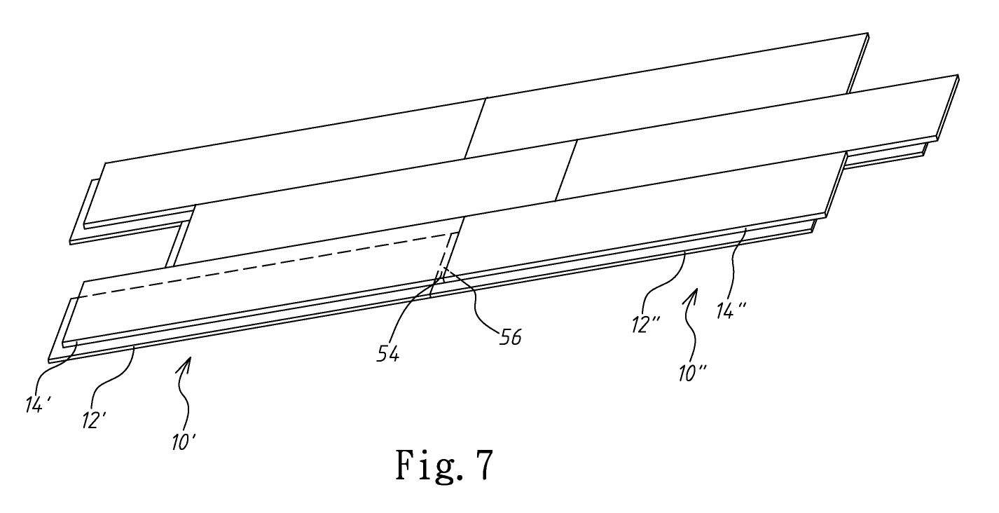

In assembling floor tiles into a floor structure according to the present invention as shown in FIG. 7, the assembly steps required are described as follows: a first surface layer 14′ is combined with a first bottom layer 12′ into a first floor tile 10′; and a second surface layer 14″ is combined with second bottom layer 12″ into a second floor tile 10″. Therefore, in case it is desired to connect the first and second floor tiles 10′ and 10″ to each other, then all that has to do is to connect a bottom surface of the first offset area 54 of the first surface layer 14′ onto a top surface of the second offset area 56 of the second bottom layer 12″. Since each of the floor tiles can be bonded to each other in vertical and horizontal directions in a side-by-side, stable, and compact manner as mentioned above, as such, the floor tile structure formed by the floor tiles according to the present invention will not offset or dislocate at random, while keeping fairly good stability.

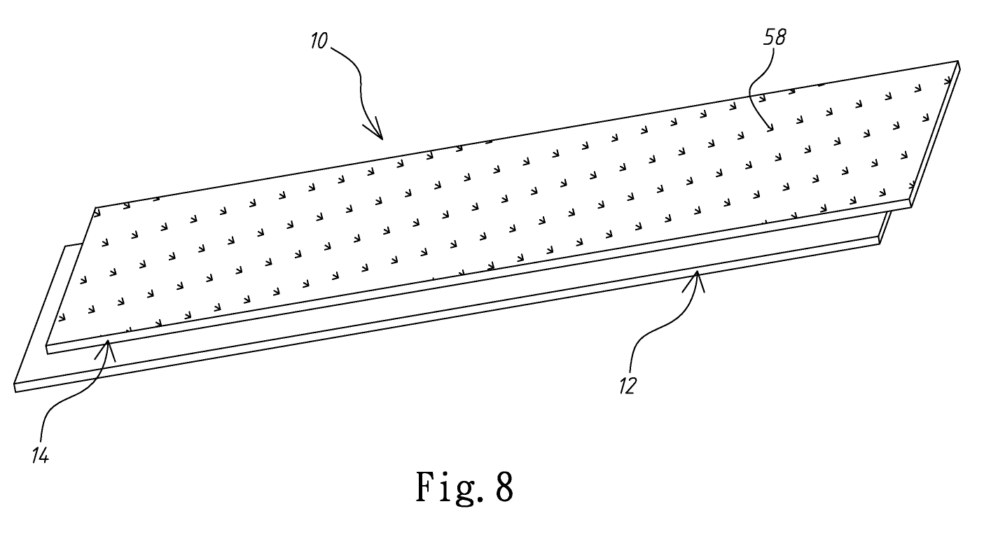

Finally, refer to FIG. 8 for a perspective view of a floor covering structure containing velcro according to a second embodiment of the present invention. As shown in FIGS. 1 & 8, the only difference between the second embodiment of FIG. 8 and the first embodiment of FIG. 1 is that, in the second embodiment, the surface layer 14 is provided with a design pattern 58, while the remaining portions are the same as those of the first embodiment. As mentioned earlier, the surface layer 14 is formed by a second velcro layer, a second bottom material layer, a second intermediate bottom material layer, a second surface material layer, and a second transparent material layer; while the design pattern 58 of FIG. 8 is located on a top surface of a second surface material layer of a surface layer 14, so that the top surface of the second surface material layer is provided with the design pattern 58. As such, since a second transparent material layer is disposed on the second surface material layer, such that upon completion of installing the floor tiles, the design pattern 58 is still visible to people viewing from above, hereby enhancing the aesthetic effects of a floor tile structure. Moreover, in case that it is desired to change the design pattern 58, all it has to do is to tear off and remove the surface layer 14 directly from the bottom layer 12, and replacing it with another surface layer having other design pattern.

Summing up the above, in the present invention, a surface layer and a bottom layer of a floor tile can be made to engage each other through a velcro layer, thus achieving a temporary and stable connection, so that in assembling this kind of floor tiles, if it is required, the surface layer can be torn off and removed from the top surface of a bottom layer, and then it can be reconnected with the bottom layer again, while keeping the surfaces of the surface layer and bottom layer undamaged and intact.

The above detailed description of the preferred embodiments is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A floor covering structure containing velcro, comprising:
a surface layer, including a first velcro layer and a first surface material layer, said first surface material layer is disposed on said first velcro layer; and
a bottom layer, including a second velcro layer, said first and second velcro layers are engaged and connected to each other.

2. The floor covering structure containing velcro as claimed in claim 1, wherein
said surface layer further comprising:
a bottom material layer, provided on said first velcro layer;
an intermediate bottom material layer, disposed on said bottom material layer, and said first surface material layer is disposed on said intermediate bottom material layer; and
a transparent material layer, disposed on said first surface material layer.

3. The floor covering structure containing velcro as claimed in claim 1, wherein
said bottom layer further comprising:
said bottom material layer;
said intermediate bottom material layer, disposed on said bottom material layer;
a second surface material layer, disposed on said intermediate bottom material layer; and
said transparent material layer, disposed on said second surface material layer, and is used for said second velcro layer to be disposed thereon, said second velcro layer is located between said transparent material layer and said surface layer.

4. The floor covering structure containing velcro as claimed in claim 1, wherein
said surface layer is provided with a first edge, said bottom layer is provided with a second edge, said surface layer includes a first offset area along a portion of said first edge, and a remaining portion of said surface layer is a first overlapping area, said bottom layer includes a second offset area along a portion of said second edge, and said remaining portion of said bottom layer is a second overlapping area, and said first and second overlapping areas overlap each other, said first offset area extends and protrudes outside said second edge of said bottom layer, and said second offset area extends and protrudes outside said first edge of said surface layer.

5. The floor covering structure containing velcro as claimed in claim 4, wherein
said first offset area is of an L shape.

6. The floor covering structure containing velcro as claimed in claim 4, wherein
said second offset area is of an L shape.

7. The floor covering structure containing velcro as claimed in claim 1, wherein
said surface layer is provided with two first length sides and two first width sides, said bottom layer is provided with two second length sides and two second width sides, said first and second length sides are parallel to each other, and said first and second width sides are parallel to each other.

8. The floor covering structure containing velcro as claimed in claim 7, wherein
a distance between said first length side and said nearest second length side is 10˜15 mm.

9. The floor covering structure containing velcro as claimed in claim 7, wherein
a distance between said first width side and said nearest second width side is 10˜15 mm.

10. The floor covering structure containing velcro as claimed in claim 7, wherein
said first and second length sides are both 914.4 mm.

11. The floor covering structure containing velcro as claimed in claim 7, wherein
said first and second width sides are both 152.4 mm.

12. The floor covering structure containing velcro as claimed in claim 1, wherein
a surface of said first surface material layer is further provided with a design pattern.

13. The floor covering structure containing velcro as claimed in claim 1, wherein
said surface layer is of a rectangular shape.

14. The floor covering structure containing velcro as claimed in claim 1, wherein
said bottom layer is of a rectangular shape.

15. The floor covering structure containing velcro as claimed in claim 1, wherein
a top surface of said surface layer is an anti-fungi & wear-resistant surface.

16. The floor covering structure containing velcro as claimed in claim 1, wherein
a bottom surface of said bottom layer is a slide-prevention surface.

17. The floor covering structure containing velcro as claimed in claim 1, wherein
said first and second velcro layers comprise Polyvinylchloride (PVC), di-isononyl phthalate (DINP), stabilizer, colophony, limestone powder, or Aluminum hydroxide (Al(OH)₃) as an anti-flaming agent.

18. The floor covering structure containing velcro as claimed in claim 1, wherein
said bottom surface of said first velcro layer is provided with a plurality of protrusion hooks, and said top surface of said second velcro layer is made of said raised fabric, such that said plurality of protrusion hooks and said raised fabric are engaged and connected to each other.

19. The floor covering structure containing velcro as claimed in claim 1, wherein
said bottom surface of said first velcro layer is made of said raised fabric, and said top surface of said second velcro layer is provided with said plurality of protrusion hooks, such that said plurality of protrusion hooks and said raised fabric are engaged and connected to each other.
